(19) United States
(12) Patent Application Publication
(10) Pub. No.: US 2006/0069823 A1
(43) Pub. Date: Mar. 30, 2006

(54) Parallel-to-serial converter circuit, electric device, and semiconductor device

(75) Inventor: Katsuhisa Ikeuchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/221,891

(22) Filed: Sep. 9, 2005

(30) Foreign Application Priority Data
Sep. 27, 2004 (JP) 2004-278869

(51) Int. Cl. G06F 13/38

(52) U.S. Cl. 710/71

(57) ABSTRACT

To provide a parallel-to-serial converter circuit and electric device capable of saving power consumed even though no parallel data to be transferred is supplied. A parallel-to-serial converter circuit according to the present invention includes a data converter circuit receiving RGB parallel data and dot clocks, and converting the RGB parallel data into RGB serial data in response to a multiplied clock, and a PLL circuit outputting the multiplied clock, and stopping output of the multiplied clock in response to a standby signal.

### BACKGROUND OF THE INVENTION

1. Field of the Invention

The present invention relates to a parallel-to-serial converter circuit, an electric device, and a semiconductor device. In particular, the invention relates to a parallel-to-serial converter circuit, electric device, and semiconductor device equipped with a PLL circuit.

2. Description of Related Art

In keeping with a recent trend toward downsizing of an electric device such as a cellular phone, there is a growing demand for reduction in power consumption of the electric device. In such an electric device, a parallel interface for transferring parallel data or serial interface for transferring serial data is utilized as an internal or external interface.

As an example of the serial interface, current mode advanced differential signaling (CMADS) has been known. In the CMADS, a large amount of data can be transferred at high speeds via the CMADS bus of a small number of lines. One disclosed in Japanese Unexamined Patent Publication NO. 2003-60061 has been known as a conventional semiconductor integrated circuit based on the CMADS.

For example, a parallel-to-serial converter circuit is necessary for transferring the parallel data via a serial interface such as the CMADS bus. FIG. 11 is a circuit diagram showing a configuration of a conventional parallel-to-serial converter circuit. The conventional parallel-to-serial converter circuit includes, as shown in FIG. 11, a data converter circuit 101 and a PLL circuit 102.

The PLL circuit 102 multiplies (a frequency of) an input source clock to be multiplied, and thus generates a multiplied clock for data conversion. The data converter circuit 101 receives parallel data in synchronism with a parallel clock (parallel-transmission clock), converts the input parallel data to serial data in response to the multiplied clock supplied from the PLL circuit 102, and outputs the serial data in synchronism with a serial clock (serial-transmission clock).

It has now been discovered that, in the conventional parallel-to-serial converter circuit, even when parallel data to be transferred is not input, the PLL circuit keeps operating. In other words, even when the supply of the source clock to be multiplied is suspended, the PLL circuit keeps the oscillation at the free-running frequency due to the free-running of the VCO. Therefore, even when parallel data to be transferred is no longer input, the PLL circuit undesirably consumes several hundred microamperes of current approximately.

As mentioned above, in the conventional parallel-to-serial converter circuit, even when the parallel-to-serial conversion is unnecessary as in the case where no parallel data to be transferred is supplied, the internal PLL circuit keeps operating, leading to wasteful power consumption.

### SUMMARY OF THE INVENTION

According to an aspect of the invention there is provide a parallel-to-serial converter circuit which comprises a data converter circuit receiving parallel data and a parallel transfer clock and converting the parallel data into serial data in response to a parallel-to-serial conversion clock, and a PLL circuit outputting the parallel-to-serial conversion clock and stopping output of the parallel-to-serial conversion clock in response to a PLL control signal. According to the parallel-to-serial converter circuit, the operation of the PLL circuit is controlled based on the PLL control signal, whereby the operation of the PLL circuit is stopped when the parallel-to-serial conversion is unnecessary, for instance, and power consumption of the PLL circuit and the data converter circuit can be reduced.

According to another aspect of the invention there is provide an electric device which comprises an image data generating unit generating parallel image data, a parallel-to-serial conversion unit converting the parallel image data to serial image data and including a PLL circuit stopping generation of clock in response to a PLL control signal, and a display unit displaying an image based on the serial image data. According to the electric device, the operation of the PLL circuit is controlled based on the PLL control signal, whereby the operation of the PLL circuit is stopped when the parallel-to-serial conversion is unnecessary, for instance, and power consumption of the PLL circuit and the data converter circuit can be reduced.

According to still another aspect of the invention there is provide a semiconductor device which comprises an image data generating unit generating parallel image data, and a parallel-to-serial conversion unit converting the parallel image data to serial image data and including a PLL circuit stopping generation of clock in response to a PLL control signal. According to the semiconductor device, the operation of the PLL circuit is controlled based on the PLL control signal, whereby the operation of the PLL circuit is stopped when the parallel-to-serial conversion is unnecessary, for instance, and power consumption of the PLL circuit and the data converter circuit can be reduced.

According to the present invention, it is possible to provide a parallel-to-serial converter circuit, an electric device, and a semiconductor device, which are capable of saving power consumption when parallel-to-serial conversion is unnecessary as in the case where no parallel data to be transferred is supplied.

### BRIEF DESCRIPTION OF THE DRAWINGS

The above and other objects, advantages and features of the present invention will be more apparent from the following description taken in conjunction with the accompanying drawings, in which:

FIG. 1 is a schematic diagram showing a cellular phone according to the present invention;

FIG. 2 is a circuit diagram showing the structure of a parallel-to-serial conversion unit according to the present invention;

FIG. 3 is a block diagram showing the configuration of a data converter circuit according to the present invention;

FIG. 4 is a flowchart showing an operational flow of a cellular phone according to the present invention;

FIG. 5 is a flowchart showing an operational flow of a cellular phone according to the present invention;

FIG. 6 is a circuit diagram showing the structure of a parallel-to-serial conversion unit according to the present invention;

FIG. 7 is a block diagram showing the configuration of a PLL control circuit according to the present invention;

FIG. 8 is a flowchart showing an operational flow of a PLL control circuit according to the present invention;

FIG. 9 is a timing chart showing an operation of a PLL control circuit according to the present invention;

FIG. 10 is a schematic diagram showing a cellular phone according to the present invention; and

FIG. 11 is a circuit diagram showing the configuration of a conventional parallel-to-serial converter circuit.

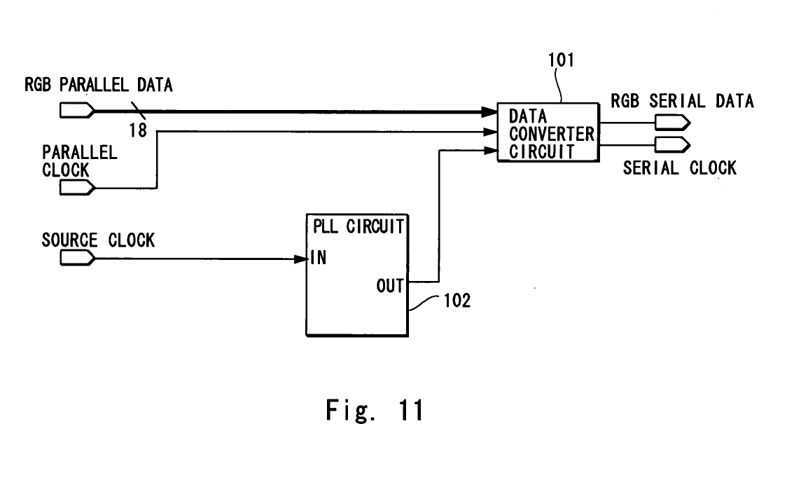

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

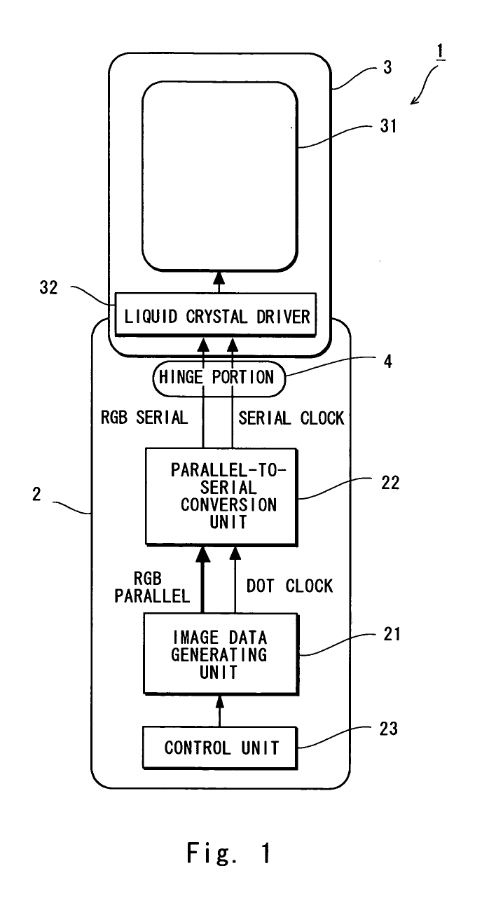

Referring first to FIG. 1, the structure of a cellular phone according to a first embodiment of the present invention is described. A cellular phone 1 includes, as shown in FIG. 1, a lower main body 2, and an upper main body 3, which are rotatably coupled together through a hinge portion 4.

The lower main body 2 includes an image data generating unit 21, a parallel-to-serial conversion unit 22, and a control unit 23. The upper main body 3 includes a liquid crystal panel 31, and a liquid crystal driver 32. Besides, the lower main body 2 is provided with a microphone, key buttons, and the like. The upper main body 3 includes a speaker etc. One side of the lower main body 2 furnished with the key buttons etc. is referred to as an operation panel, and one side of the upper main body 3 furnished with the liquid crystal panel 31 is called a display screen. A user views displayed contents on the liquid crystal panel 31.

The cellular phone 1 is of a folding type, a revolving type, a reversing type, or the like, and the upper main body 3 can turn about the hinge portion 4. Taking the folding type cellular phone 1 as an example, the axial direction of the hinge portion 4 is in parallel to the operation panel of the lower main body 2. Thus, the cellular phone can be folded such that the display screen of the upper main body 3 overlaps the operation panel of the lower main body 2. Taking the revolving type cellular phone 1 as another example, the axial direction of the hinge portion 4 extends vertically to the operation panel of the lower main body 2. Thus, the cellular phone is folded (in a sliding manner) such that the rear side of the upper main body 3 (side opposite to the display screen) and the operation panel of the lower main body 2 overlap each other. Taking the reversing type cellular phone 1 as still another example, the hinge portion 4 has two shafts, one of which extends in parallel to the operation panel of the lower main body 2, and the other of which extends vertically to the operation panel of the lower main body 2. The cellular phone can be folded such that the display screen of the upper main body 3 overlaps the operation panel of the lower main body 2, or the rear side of the upper main body 3 overlaps the operation panel of the lower main body 2.

Note that in the following description, the term “operation state” implies a state in which the cellular phone 1 is opened, and a user presses key buttons etc. of the lower main body 2. The term “standby state” implies a state in which the cellular phone 1 is closed, and a user does not press the key buttons etc. of the lower main body 2 (non-operation state). Further, it is possible to switch between the operation state and the standby state by pressing the key buttons etc., instead of opening/closing the cellular phone 1.

The image data generating unit 21 and the parallel-to-serial conversion unit 22 are connected via a parallel bus (parallel interface). The parallel bus allows input/output of RGB parallel data and a dot clock. The parallel bus transfers, for example, 18-bit RGB parallel data at a time. The RGB parallel data consists of arrayed R (red), G (green), and B (blue) data, which constitute one pixel. For example, the R, G, and B data are each 6-bit data. The dot clock is an image synchronization signal that corresponds to image data of one dot. The dot clock serves as a parallel-transmission clock that defines the timing for transferring the RGB parallel data.

The hinge portion 4 varies in shape and size depending on its shaft. Assuming that the revolving or reversing type cellular phone 1 is used, the hinge portion has the smaller width than the upper main body 3 or the lower main body 2. Thus, the hinge portion 4 is provided with a narrow serial bus (serial interface).

The parallel-to-serial conversion unit 22 and the liquid crystal driver 32 are connected via the serial bus. The serial bus allows input/output of RGB serial data and serial clock. The serial bus is, for example, a CMADS bus using a pair or two pairs of bus lines. The serial bus transfers the RGB serial data on a bit-to-bit basis. The use of the CMADS bus saves power consumption as well as enables high-speed data transfer with a fewer lines. The serial clock is CMADS clock or the like, which serves as serial-transmission clock that defines a timing for transferring the RGB serial data.

The control unit 23 is, for example, a CPU, and performs various kinds of control over the cellular phone 1. The control unit 23 makes control to display desired image data on the liquid crystal panel 31 in response to user's manipulation. Besides, the control unit 23 controls output of image data from the image data generating unit 21, and controls the converting operation of the parallel-to-serial conversion unit 22, especially, an operation of a PLL circuit in the parallel-to-serial conversion unit 22 (output of multiplied clock).

The image data generating unit 21 is, for example, a graphic chip or application chip, and generates image data to be displayed on the liquid crystal panel 31. The image generating unit 21 generates RGB parallel data as image data in response to control of the control unit 23. When transferring RGB parallel data, the image data generating unit 21 provides a dot clock to the parallel-to-serial conversion unit 22, and outputs RGB parallel data in synchronism with the dot clock. Further, if no RGB parallel data is transferred, the image data generating unit 21 supplies no dot clock to the parallel-to-serial conversion unit 22.

The parallel-to-serial conversion unit 22 is, for example, a bridge IC (bridge chip), and converts parallel data into serial data. The parallel-to-serial conversion unit 22 receives RGB parallel data from the image data generating unit 21 in response to the dot clock, converts the RGB parallel data into RGB serial data, and outputs the RGB serial data to the liquid crystal driver 32 in synchronism with the serial clock. Further, the parallel-to-serial conversion unit 22 switches the operating state of the internal PLL circuit under the control of the control unit 23, and carries out parallel-to-serial conversion.

The liquid crystal driver 32 is a driver circuit for displaying image data on the liquid crystal panel 31. The liquid crystal driver 32 receives RGB serial data from the parallel-to-serial conversion unit 22 in response to the serial clock, converts the RGB serial data into parallel data, and then generates and supplies driving signals to the liquid crystal panel 31.

The liquid crystal panel 31 is, for example, a liquid crystal display panel capable of color display. The liquid crystal panel 31 displays image data in response to driving signals supplied from the liquid crystal driver 32. For example, when a user brings the cellular phone 1 into an operation state, the image data is displayed on the liquid crystal panel 31. When a user brings the cellular phone 1 into a standby state, no image data is displayed on the liquid crystal panel 31.

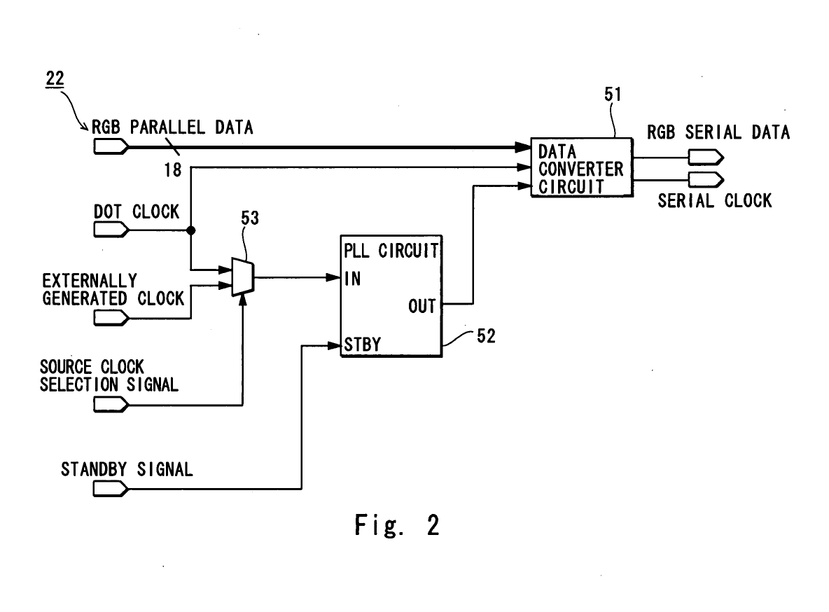

Referring next to FIG. 2, the structure of the parallel-to-serial conversion unit according to this embodiment is described. The parallel-to-serial conversion unit 22 includes, as shown in FIG. 2, a data converter circuit 51, a PLL circuit 52, and a multiplexer 53. As discussed above, the parallel-to-serial conversion unit 22 receives the RGB parallel data and the dot clock from the image data generating unit 21, and outputs the RGB serial data and serial clock.

The parallel-to-serial conversion unit 22 further receives an external clock aside from the dot clock, a source clock selection signal for selecting a source clock to be multiplied, and a standby signal for switching the parallel-to-serial converter circuit to a standby state. The external clock and the source clock selection signal may be supplied either from the image data generating unit 21, from the control unit 23 or other components such as an external oscillator. The standby signal is applied from, for example, the control unit 23.

The multiplexer 53 is a circuit for switching the source clock to be supplied to the PLL circuit 52. The multiplexer 53 receives the dot clock and the external clock, and selects either one of the two in accordance with the source selection signal to apply the selected one to the PLL circuit 52 as the source clock to be multiplied. Note that it is possible to directly input either the dot clock or the external clock to the PLL circuit 52 not through the multiplexer 53.

The PLL circuit 52 is a frequency-multiplying circuit for multiplying the input signal. The PLL circuit 52 multiplies the source clock applied to an IN terminal (input terminal) from the multiplexer 53, and passes the thus-multiplied clock to the data converter circuit 51 through an OUT terminal (output terminal). The multiplied clock is a parallel-to-serial conversion clock necessary for the data converter circuit 51 to convert parallel data to serial data, which can be called a serial clock.

Also, in this embodiment, a standby signal (PLL control signal) applied to a STBY terminal(standby terminal) controls the output of the multiplied clock from the PLL circuit 52. The PLL circuit 52 switches between an active state and a standby state in response to the standby signal. The active state refers to a state in which free-running clock etc. is output as the multiplied clock. In this state, the circuit continuously consumes power since an internal circuit such as a VCO keeps operating. The standby state refers to a state in which no multiplied clock is output. In this state, the operation of the internal circuit is suspended, so no power is consumed.

For example, the control unit 23 sends “on” standby signal to put the PLL circuit 52 in a standby state in the case of displaying no image data. On the other hand, the control unit 23 sends “off” standby signal to thereby put the PLL circuit 52 in an active state in the case of displaying image data. Hence, power consumption can be reduced when no image data is displayed.

The data converter circuit 51 converts parallel data to serial data. The data converter circuit 51 receives RGB parallel data, the dot clock, and the multiplied clock output from the PLL circuit 52. The data converter circuit 51 acquires the RGB parallel data based on the dot clock, and converts the RGB parallel data into the RGB serial data based on the multiplied clock to output the resultant RGB serial data and the multiplied clock as the serial clock as well.

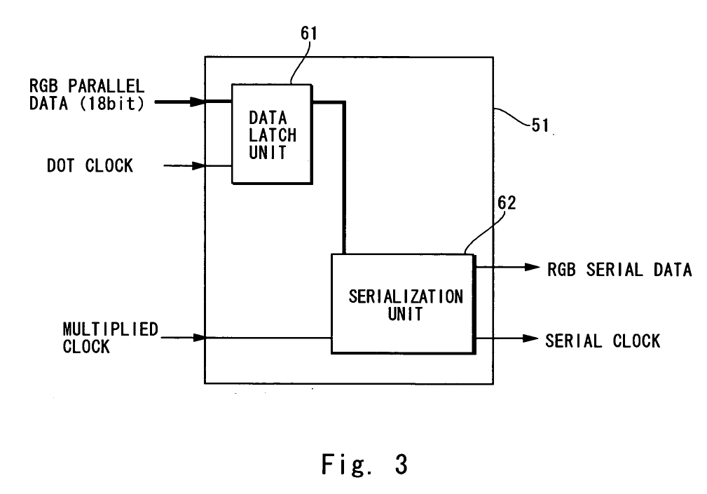

For example, the data converter circuit 51 can be configured as shown in FIG. 3. The data converter circuit 51 includes a data latch unit 61 and a serialization unit 62.

The data latch unit 61 latches parallel data. It receives RGB parallel data and dot clocks. The data latch unit 61 latches the RGB parallel data in synchronism with the dot clock, and provides the latched RGB parallel data to the serialization unit 62.

The serialization unit 62 converts the parallel data into serial data, and receives the RGB parallel data from the data latch unit 61, and the multiplied clock from the PLL circuit 52. The serialization unit 62 sequentially selects RGB parallel data in synchronism with the input multiplied clock to send out the selected data as the RGB serial data, and supply the multiplied clock as the serial clock as well.

For example, for putting out the RGB serial data on the CMADS bus, the serialization unit 62 is provided with a CMADS transmitter circuit at an output stage. Further, the liquid crystal driver 32 on the reception side is provided with a CMADS receiver circuit. With this provision, a single CMADS transmitter circuit can transfer data to plural CMADS receiver circuits. Further, the CMADS transmitter circuit includes an open-drain MOS transistor operating in accordance with an input signal. When the open-drain MOS transistor is turned ON, current is supplied from the CMADS receiver circuit, and a small-amplitude differential signal is used to transfer data, thereby realizing a high-speed circuit operation and low power consumption. Further, even if plural CMADS receiver circuits are used, data can be stably transferred by reducing an on-resistance of the open-drain MOS transistor to a low enough level.

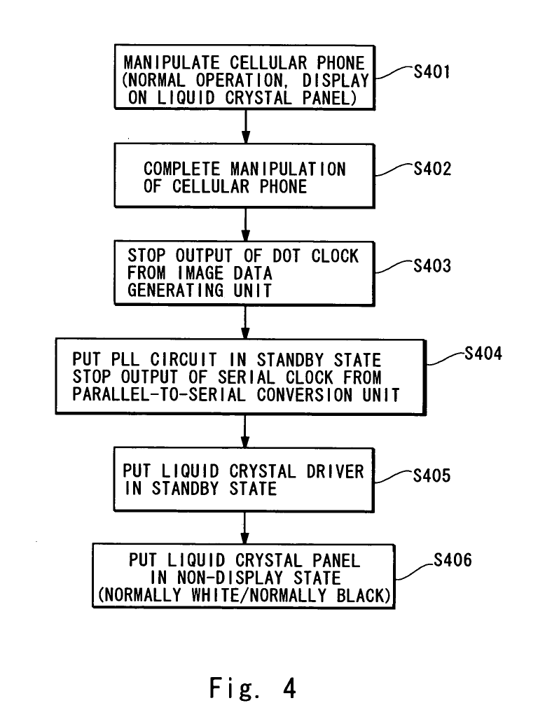

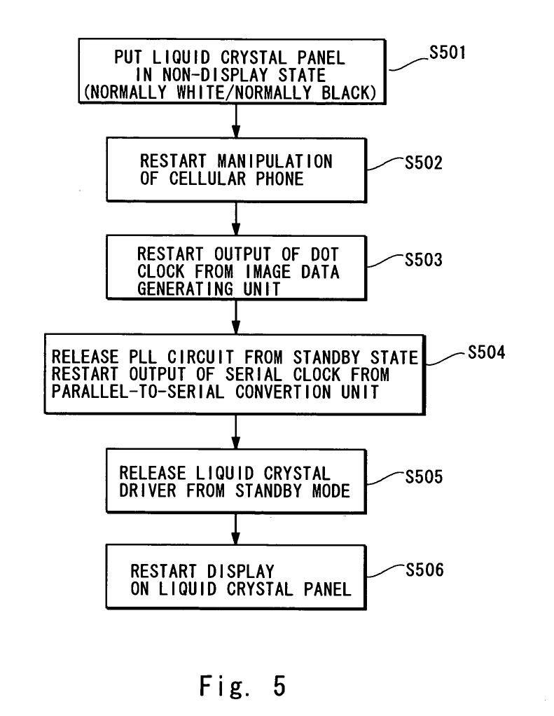

Referring next to FIGS. 4 and 5, an operation of the cellular phone according to this embodiment is described. FIG. 4 is a flowchart illustrative of an operational flow when the cellular phone 1 is switched from the operation state to the standby state.

As shown in FIG. 4, image data is being displayed on the liquid crystal panel 31 while a user manipulates the cellular phone 1 (S401). For example, in the operation state, that is, an open state of the cellular phone 1, the image data generating unit 21 outputs the RGB parallel data that corresponds to desired image data, under the control of the control unit 23. The image data is then displayed on the liquid crystal panel 31 by means of the parallel-to-serial conversion unit 22 and the liquid crystal driver 32.

Then, the user completes the manipulation of the cellular phone 1 (S402). For example, when the user folds the cellular phone 1 to switch it to the standby state, the control unit 23 detects this state, and effects the following processing to switch the liquid crystal panel 31 into a non-display state.

First, the control unit controls the image data generating unit 21 so as to stop outputting the dot clock (S403). For example, the image data generating unit 21 stops generating image data under the control of the control unit 23, and stops outputting the RGB parallel data and dot clock.

Next, the control unit puts a PLL circuit 52 of the parallel-to-serial conversion unit 22 into the standby state, and makes the PLL circuit 52 stop outputting the serial clock (S404). For example, the parallel-to-serial converter circuit 23 puts the PLL circuit 52 into the standby state in response to the standby signal supplied from the control unit 23. Thus, no multiplied clock is applied to the data converter circuit 51 and no serial clock is output from the data converter circuit 51.

Subsequently, the control unit brings the liquid crystal driver 32 into a standby mode (S405). Not receiving serial clocks, the liquid crystal driver 32 enters a standby mode, and stops outputting driving signals to the liquid crystal panel 31.

Subsequently, the control unit puts the liquid crystal panel 31 into a non-display state (S406). For example, when no driving signal is sent from the liquid crystal driver 32, the liquid crystal panel 31 enters the non-display state. At this time, in a normally white mode, the liquid crystal panel 31 goes into white state. Meanwhile, in a normally black mode, the liquid crystal panel 31 goes into a black state. In this way, when the cellular phone 1 is put in a standby state, the liquid crystal panel 31 stops displaying an image.

FIG. 5 is a flowchart showing an operational flow when the cellular phone 1 is switched from the standby state to the operation state. As shown in FIG. 5, the liquid crystal panel 31 remains in a non-display state until the user manipulates the cellular phone 1 again (S501). As discussed above, when the cellular phone 1 is in a standby state, no image data is displayed on the liquid crystal panel 31.

Then, the user restarts manipulating the cellular phone 1 (S502). For example, when the user opens the cellular phone 1 to put the cellular phone in an operation state, the control unit 23 detects this state, and effects the following processing so as to start image display on the liquid crystal panel 31.

First, the control unit controls the image data generating unit 21 so as to restart outputting a dot clock (S503). For example, the image data generating unit 21 starts generating image data, and outputting RGB parallel data and dot clocks under the control of the control unit 23.

Then, the parallel-to-serial conversion unit 22 releases the PLL circuit 52 from the standby state, and thus restarts outputting serial clocks (S504). For example, the parallel-to-serial conversion unit 22 makes the PLL circuit 52 return from the standby state to the active state in accordance with the standby signal supplied from the control unit 23. Then, the data converter circuit 51 receives the multiplied clock, and outputs the serial clock together with RGB serial data having undergone parallel-to-serial conversion.

Next, the control unit makes the liquid crystal driver 32 return from the standby state (S505). For example, receiving the serial clock, the liquid crystal driver 32 returns from the standby mode to convert the RGB serial data into driving signals, and applying the driving signals to the liquid crystal panel 31.

Next, the liquid crystal panel 31 restarts displaying an image (S506). For example, in response to the driving signal from the liquid crystal driver 32, the liquid crystal panel 31 displays image data. Thus, when the cellular phone 1 is put in an operation state, the liquid crystal panel 31 restarts image display.

With such a structure, in the case where the cellular phone enters a standby state or the like, and there is no image data to be transferred, the PLL circuit used for parallel-to-serial conversion is brought into a standby state, thereby saving power. When the PLL circuit is put in a standby state, a multiplied clock is not generated to thereby halt the operation of the data converter circuit. This accomplishes much lower power consumption. In particular, power saving is the top priority for the cellular phone, so large beneficial effects can be expected.

### Second Embodiment

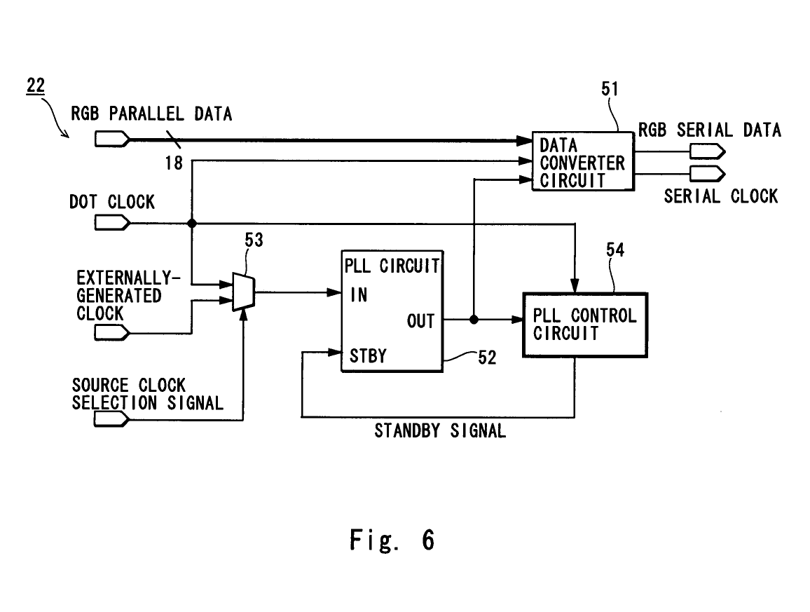

Referring next to FIG. 6, the structure of a parallel-to-serial conversion unit according to a second embodiment of the present invention is described. The parallel-to-serial conversion unit 22 is used in the cellular phone 1 of FIG. 1, similar to the circuit of FIG. 2. Further, the operation of the cellular phone 1 is the same as the illustrated examples of FIGS. 4 and 5. Note that in FIG. 6, the same components as those of FIG. 2 are denoted by the same reference numerals, and their description is omitted here.

The parallel-to-serial conversion unit 22 of this embodiment includes a PLL control circuit 54 in addition to the structural components of FIG. 2, and thus dispenses with the terminal receiving a standby signal.

The PLL control circuit 54 controls the output operation of the PLL circuit 52 based on the dot clock. In the first embodiment, when there is no image data to be transferred, the PLL circuit 52 is put in a standby state in response to a standby signal from the control unit 23 or the like. In this embodiment, however, the PLL control circuit 54 detects the absence of image data to be transferred, generates and supplies the standby signal, and thus puts the PLL circuit 52 in the standby state.

The PLL control circuit 54 receives the dot clock and the multiplied clock from the PLL circuit 52. If no dot clock has been input over a predetermined period, the PLL control circuit 54 determines the absence of RGB parallel data to supply the standby signal to the PLL circuit 52, and bring the PLL circuit 52 into the standby state. Preferably, the PLL control circuit 54 is so configured as to output the standby signal if no dot clock has been input over a predetermined period. Instead, the circuit may be so configured as to output the standby signal in response to the stop of the input dot clock.

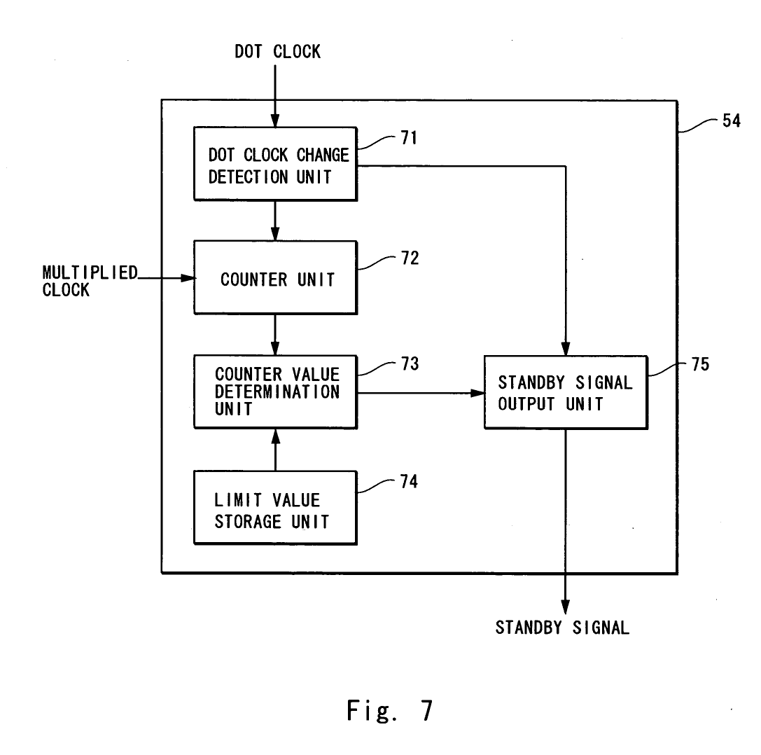

Referring next to FIG. 7, the configuration of the PLL control circuit according to this embodiment is described. The PLL control circuit 54 includes, as shown in FIG. 7, a dot clock change detection unit 71, a counter unit 72, a counter value determination unit 73, a limit value storage unit 74, and a standby signal output unit 75.

The dot clock change detection unit 71 detects a change in the dot clock. For example, the dot clock change detection unit 71 detects a dot clock change from a low voltage level to a high voltage level, or from the high level to the low level. The dot clock change detection unit 71 may detect both or one of the change from the low level to the high level and the change from the high level to the low level. For detecting the change from the low level to the high level, for example, the dot clock change detection unit 71 may detect the change to a predetermined signal level. When the dot clock changes in level, the dot clock change detection unit 71 outputs the detection result to the counter unit 72 or the standby signal output unit 75.

The counter unit 72 counts the clock pulses of the multiplied clock. That is, the counter unit 72 increments a counter value in accordance with the multiplied clock. Then, the counter unit 72 clears (resets) the counter value back to zero when the dot clock change detection unit 71 detects the change in the dot clock. In short, the counter unit 72 counts the clock pulses generated during a period for which the supply of the dot clock is suspended, that is, the dot clock does not change in level. The counter unit 72 sends the counting result to the counter value determination unit 73.

The limit value storage unit 74 stores a limit value of the counter value of the counter unit 72. The limit value defines a period from when a dot clock no longer changes in level until the PLL circuit 52 enters a standby state. In other words, the limit value defines a period for detecting the absence of RGB parallel data to be transferred.

The counter value determination unit 73 determines the counter value of the counter value 72. The counter value determination unit 73 determines whether or not the counter value reaches the limit value stored in the limit value storage unit 74 to thereby detect the absence of RGB parallel data to be transferred. If the counter value reaches the limit value, the counter value determination unit 73 sends the determination result to the standby signal output unit 75. Further, the counter value determination unit 73 may let the counter unit 72 stop counting while the counter value remains at or over the limit value.

The standby signal output unit 75 outputs a standby signal that brings the PLL circuit 52 into a standby state. The standby signal output unit 75 sends the “off” standby signal while the dot clock change detection unit 71 detects any change. While receiving the “off” standby signal, the PLL circuit 52 is in the active state. If the counter value determination unit 73 determines that the counter value reaches the limit value, the standby signal output unit 75 sends the “on” standby signal. While receiving the standby signal, the PLL circuit 52 is in the standby state.

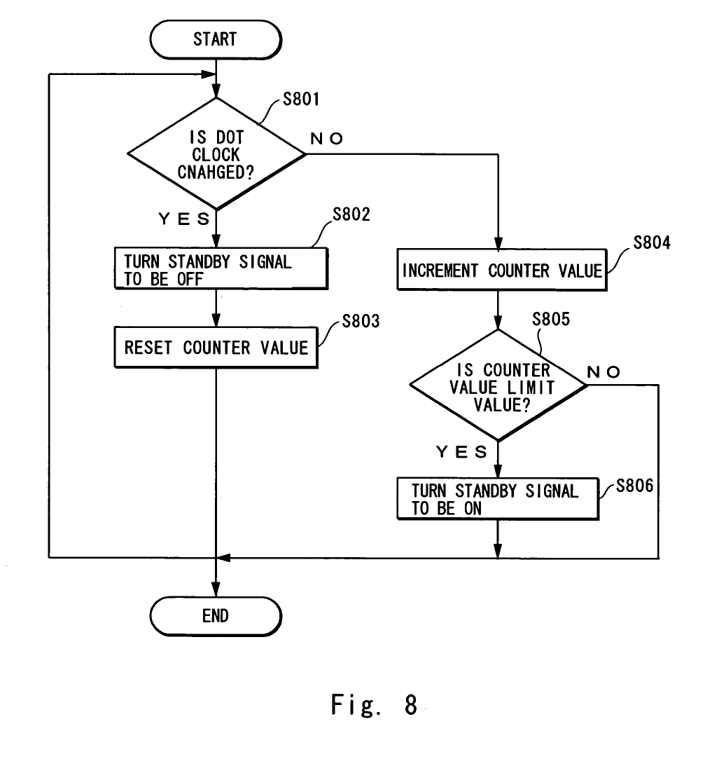

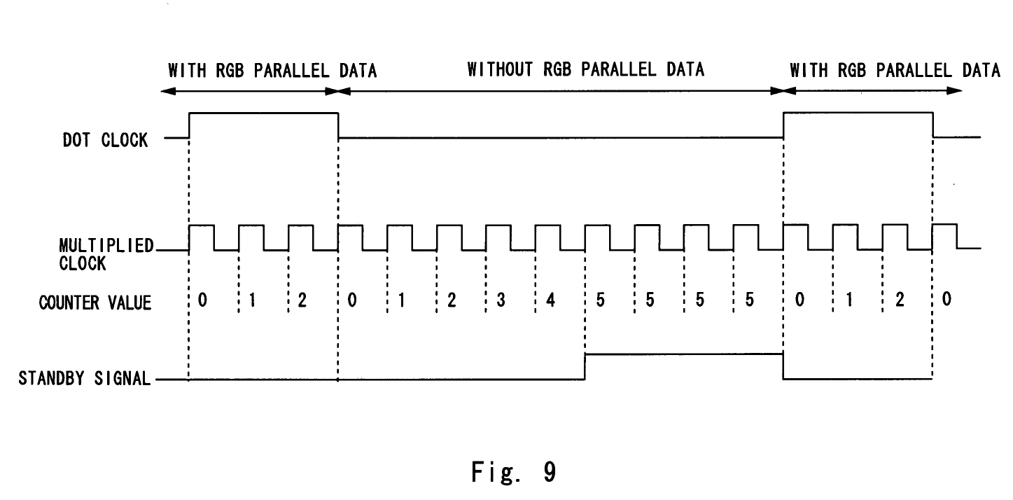

Referring next to FIGS. 8 and 9, the operation of the PLL control circuit according to this embodiment is described. FIG. 8 is a flowchart showing an operational flow of the PLL control circuit 54.

As shown in FIG. 8, the PLL control circuit 54 first determines whether or not the dot clock changes in level (S801). For example, the dot clock change detection unit 71 continuously checks a level of the dot clock to detect its change.

In step S801, if it is determined that the dot clock changes in level, the standby signal is turned to be off (S802). For example, when the dot clock change detection unit 71 detects the change in the dot clock level, the standby signal output unit 75 turns the standby signal to be off.

Next, the counter value is reset (S803). For example, when the dot clock change detection unit 71 detects the change in the dot clock level, the counter unit 72 resets a counter value. Note that step S802 may follow step S803. Then, step S801 is executed to monitor the dot clock.

In step S801, if the dot clock is determined unchanged, the counter value is incremented (S804). For example, the counter unit 72 counts the clock pulses of the multiplied clock until the dot clock change detection unit 71 detects any change in the dot clock level. Also, if the counter value has reached the limit value, the counter value needs not to be incremented.

Following this, it is determined whether or not the counter value reaches a limit value (S805). For example, the counter value determination unit 73 determines whether or not the counter value of the counter unit 72 reaches a limit value stored in the limit value storage unit 74.

In step S805, if the counter value is determined to reach a limit value, the standby signal is turned to be on (S806). For example, when the counter value determination unit 73 determines the counter value to reach the limit value, the standby signal output unit 75 turns the standby signal to be on.

In step S805, if the counter value is determined not to reach the limit value, step S801 is additionally executed. For example, when the counter value determination unit 73 determines that the counter value has not yet reached the limit value, step S801 is additionally executed to monitor a dot clock.

FIG. 9 is a timing chart showing an operation of the PLL control circuit 54. As shown in FIG. 9, the dot clock is repeatedly switched between the high level and the low level during such a period that RGB parallel data to be transferred exists. On the other hand, the dot clock remains at the low level during such a period that there is no RGB parallel data to be transferred. The dot clock change detection unit 71 detects such a change in dot clock level. In this example, the change in dot clock from the low level to the high level and the change in dot clock from the high level to the low level are detected.

The multiplied clock supplied from the PLL circuit 52 is the dot clock or a clock obtained by multiplying an externally-generated clock. Whenever an external clock is input to the PLL circuit 52, the PLL circuit 52 outputs the multiplied external clock. Assuming that the dot clock is applied to the PLL circuit 52, when the RGB parallel data exits, the PLL circuit outputs the dot clock that has been multiplied. In contrast, when no RGB parallel data exists, the dot clock is not supplied, so a free-running clock generated in the PLL circuit 52 is output.

The counter value of the counter unit 72 is cleared back to “0” in response to the change in dot clock. The counter unit 72 increments the counter value in accordance with the number of multiplied clocks while the dot clock shows no change in level. Then, the clocks are counted until the counter value reaches a limit value, for example, “5”. After that, if the dot clock changes, the counter value is reset again.

The standby signal is turned off (low level) while the counter value is smaller than a limit value. Meanwhile, when the counter value is not smaller than the limit value, the standby signal is driven to on state (high level). The standby signal is driven to off state at the timing when the dot clock changes in level, and is turned to be on at the timing when the counter value reaches the limit value.

With such a structure, a PLL control circuit is provided in a parallel-to-serial conversion unit, so it is detected that there is no RGB parallel data to be transferred, in the parallel-to-serial conversion unit. Thus, the PLL circuit can be brought into the standby state. Therefore, it is possible to save power and reduce the number of terminals in the parallel-to-serial converter circuit as well. It is determined based on the absence/presence of a dot clock that no RGB parallel data exists. Hence, the PLL circuit can be efficiently switched to the standby state. In particular, the PLL circuit can be put in the standby state at a timing suitable for the analog operation of the PLL circuit, by detecting an unchanging state of the dot clock over a predetermined period.

### Other Embodiments of the Invention

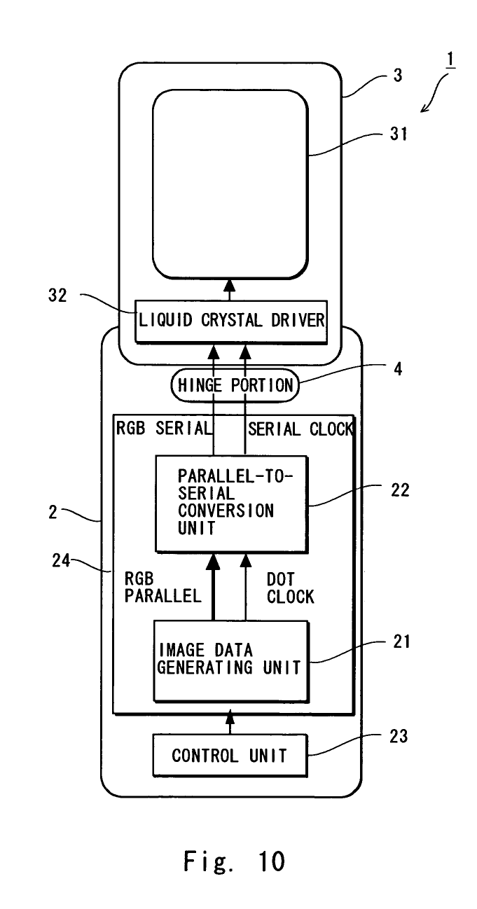

Note that in the foregoing cellular phone 1, the parallel-to-serial conversion unit 22, the image data generating unit 21, the control unit 23, and the like may be semiconductor devices each packaged into different chips. In addition, plural components may be packaged in one chip. For example, as shown in FIG. 10, an application chip 24 may be provided in a lower main body 2, and equipped with the parallel-to-serial conversion unit 22 and the image data generating unit 21. When the image data generating unit 21 and the parallel-to-serial conversion unit 22 are provided on the application chip, the cellular phone can be downsized. Further, when the application chip includes the image data generating unit 21, and a bridge IC includes the parallel-to-serial conversion unit 22, an application chip having an existing parallel interface can be utilized.

Also, in the above example, the parallel-to-serial converter circuit is provided to the cellular phone but may be applied to other electric devices in place of the cellular phone.

Further, the above example describes the parallel-to-serial converter circuit adapted to convert the RGB parallel data to the RGB serial data. However, the circuit may convert the other parallel data into corresponding serial data instead. In addition, the circuit may convert parallel data to not serial data but parallel data of a shorter bit length.

It is apparent that the present invention is not limited to the above embodiment that may be modified and changed without departing from the scope and sprit of the invention.

What is claimed is:

1. A parallel-to-serial converter circuit, comprising:
a data converter circuit receiving parallel data and a parallel transfer clock, and converting the parallel data into serial data in response to a parallel-to-serial conversion clock; and
a PLL circuit outputting the parallel-to-serial conversion clock and stopping output of the parallel-to-serial conversion clock in response to a PLL control signal.

2. The parallel-to-serial converter circuit according to claim 1, further comprising a PLL control circuit outputting the PLL control signal in response to the parallel transfer clock.

3. The parallel-to-serial converter circuit according to claim 2, wherein the PLL control circuit stops an output operation of the PLL circuit if the parallel transfer clock has not been input over a predetermined period.

4. The parallel-to-serial converter circuit according to claim 3, wherein the PLL control circuit includes:
a counter circuit counting clock pulses of the parallel-to-serial conversion clock while the parallel transfer clock is not input; and
an output circuit outputting the PLL control signal based on a counter value of the counter circuit.

5. The parallel-to-serial converter circuit according to claim 1, wherein:
the parallel data is parallel image data; and
the parallel transfer clock is a dot clock corresponding to the image data.

6. The parallel-to-serial converter circuit according to claim 1, wherein the parallel-to-serial conversion clock is a serial transfer clock for transferring the serial data.

7. The parallel-to-serial converter circuit according to claim 1, wherein the serial data and the parallel-to-serial conversion clock are put out on a serial bus.

8. An electric device, comprising:
an image data generating unit generating parallel image data;
a parallel-to-serial conversion unit converting the parallel image data to serial image data and including a PLL circuit stopping generation of clock in response to a PLL control signal; and
a display unit displaying an image based on the serial image data.

9. The electric device according to claim 8, wherein the clock generated in the PLL circuit is a parallel-to-serial conversion clock for converting the parallel image data to serial image data.

10. The electric device according to claim 9, wherein the parallel-to-serial conversion clock is a serial transfer clock for transferring the serial image data.

11. The electric device according to claim 8, wherein the parallel-to-serial conversion unit generates the PLL control signal based on an image synchronization signal for transferring the parallel image data.

12. The electric device according to claim 11, wherein the parallel-to-serial conversion unit stops an operation of the PLL circuit if the image synchronization signal has not been input over a predetermined period.

13. The electric device according to claim 8, further comprising a control unit controlling output of the parallel image data from the image data generating unit, and generating the PLL control signal.

14. The electric device according to claim 8, wherein:
the parallel-to-serial conversion unit and the display unit are connected through a serial bus; and
the serial image data is transferred through the serial bus.

15. A semiconductor device, comprising:
an image data generating unit generating parallel image data; and
a parallel-to-serial conversion unit converting the parallel image data to serial image data and including a PLL circuit stopping generation of clock in response to a PLL control signal.

16. The semiconductor device according to claim 15, wherein the clock generated in the PLL circuit is a parallel-to-serial conversion clock for converting the parallel image data into serial image data.

17. The semiconductor device according to claim 15, wherein the parallel-to-serial conversion unit generates the PLL control signal based on an image synchronization signal for transferring the parallel image data.
